(19) United States
(12) Patent Application Publication
(10) Pub. No.: US 2022/0410846 A1
(43) Pub. Date: Dec. 29, 2022

(54) WIPER DEVICE, WIPER SYSTEM AND METHOD FOR OPERATING THE WIPER DEVICE

(71) Applicant: Robert Bosch GmbH, Stuttgart (DE)

(72) Inventors: Akos Hegyi, Mezohegyes (HU); Bence Balint, Delegyhaza (HU); Janos Simonovics, Pecs (HU); Mate Hornyak, Pakozd (HU); Mihaly Nagy, Torokbalint (HU); Peter Deak, Budapest (HU); Peter Kosaras, Budapest (HU); Zoltan Varga, Kecskemet (HU)

(21) Appl. No.: 17/851,503

(22) Filed: Jun. 28, 2022

(30) Foreign Application Priority Data
Jun. 29, 2021 (DE) 102021206747.6

(51) Int. Cl. B60S 1/56; B60S 1/34

(52) U.S. Cl. CPC B60S 1/56; B60S 1/3463

(57) ABSTRACT

A wiper device (10a-10f) for wiping a sensor system (30a-30f), in particular a lidar system, with at least one wiper unit (12a-12f), which comprises at least one wiper lip (16a-16f) for wiping a surface (38a-38f) of the sensor system (30a-30f) and with at least one pressing unit (14a-14f). It is proposed that the pressing unit (14a-14f) comprises at least one spring element (24a; 52b; 54c, 56c; 58d; 60e; 62f, 64f) for pressing the wiper unit (12a-12f) against the surface (38a-38f).

### CROSS-REFERENCE TO RELATED APPLICATIONS

This application claims priority to DE 102021206747.6, filed Jun. 29, 2021, the entire contents of which are incorporated herein by reference.

### BACKGROUND OF THE INVENTION

A wiper device for wiping a sensor system, in particular a lidar system, with at least one wiper unit comprising at least one wiper lip for wiping a surface of the sensor system and with at least one pressing unit, has already been proposed.

### SUMMARY OF THE INVENTION

The invention is based on a wiper device for wiping a sensor system, in particular a lidar system, with at least one wiper unit, which comprises at least one wiper lip for wiping a surface of the sensor system and with at least one pressing unit.

It is proposed that the pressing unit comprises at least one spring element for pressing the wiper unit against the surface.

A “wiper device” should preferably be understood to mean at least a part, preferably a subassembly, of a windshield wiper. Preferably, the wiper device may also comprise the entire windshield wiper, in particular with a wiper blade. Preferably, the wiper device is provided for use on a vehicle and on the sensor system. Preferably, the wiper device, in particular as part of the windshield wiper, is provided for cleaning a surface, preferably a pane of the sensor system on a vehicle. Preferably, the wiper device is coupled to a vehicle. “Provided” should preferably be understood to mean specially designed, set up, configured and/or equipped. By the fact that an object is provided for a certain function, it should preferably be understood that the object fulfills and/or executes this particular function in at least one application and/or operating state. An “operating state” should preferably be understood to mean a state in which the wiper device is ready for operation for a wiping process and/or a wiping operation and/or is in a wiping mode in which the wiper lip of the wiper unit, in particular the windscreen wiper, is preferably guided over a pane, in particular the surface, of the sensor system and is advantageously applied to the surface. The surface of the sensor system may be in the form of part of a vehicle windshield of the vehicle.

Preferably, the sensor system is in the form of a lidar system. The sensor system, in particular the lidar system, is in particular at least a part, preferably at least a subassembly, of at least one lidar sensor, in particular a lidar sensor assembly. The sensor system, in particular the lidar system, may in particular also comprise the entire lidar sensor, in particular the entire lidar sensor assembly. Preferably, the sensor system, in particular the lidar system, has at least one lidar unit, which in particular comprises at least one lidar sensor element. In particular, the sensor system, in particular the lidar system, may have a number, such as two, three, four, five or the like lidar sensor elements. Preferably, the sensor system, in particular the lidar system, is arranged on a vehicle for environment detection, in particular for autonomous driving. The sensor system, in particular the lidar system, may be arranged on construction sites for the measurement of buildings, for scanning 3D contours and/or in the laboratory for research purposes. In particular, the sensor system, in particular the lidar system, and in particular by means of the at least one lidar sensor element, is provided for the detection and/or measurement of objects. Preferably, the sensor system, in particular the lidar system, is provided for use on a vehicle. Preferably, the sensor system, in particular the lidar system, is in the form of a component of the vehicle. Alternatively, the sensor system, in particular the lidar system, may be in the form of a retrofit kit for the vehicle. Preferably, the sensor system, in particular the lidar system, is provided for detecting objects in an environment of the vehicle. Preferably, the sensor system, in particular the lidar system, is coupled to the vehicle for the detection of objects, preferably in a roof area, a front area, at least one side area and/or a rear area of the vehicle. The vehicle may be in the form of a road vehicle, for example a car, a truck, or the like, as a rail vehicle such as a train, a railcar, a tram or the like and/or as a watercraft such as a ship, a boat, or the like. The vehicle may be in the form of a cleaning vehicle, in particular a cleaning robot, for example a mopping robot and/or a vacuum cleaner robot. Preferably, the sensor system, in particular the lidar system, is connected to the vehicle, in particular to a computing unit, such as an on-board computer, of the vehicle. Preferably, the sensor system, in particular the lidar system, has a covering wall, which in particular allows a laser beam of the sensor system to emanate from a housing of the sensor system and which is in particular at least essentially transparent for detecting wavelengths of the at least one lidar sensor element. Preferably, the covering wall of the sensor systems defines the surface of the sensor system as an outer surface of the covering wall. Preferably, the sensor system, in particular the covering wall, is at least partially arranged on the outside of the vehicle. Preferably, the covering wall covers the sensor system at least partially, in particular to the outside. For example, the covering wall is formed at least to a large extent of glass and/or polycarbonate. In particular, the wiper unit is provided for cleaning the covering wall mechanically, in particular by means of the wiper lip. Preferably, the wiper lip is of a rubber-like form.

Preferably, the wiper unit is provided for additional cleaning of the covering wall by means of the wiping liquid. It would be conceivable that the wiper unit has at least one, preferably a number, of fluid nozzles, which are provided, in particular in the operating state, to spray the wiping liquid onto the covering wall. For example, the at least one fluid nozzle may be connected to a fluid supply unit already present in the vehicle. Alternatively, the wiper unit may have a separate fluid supply unit which comprises, for example, at least one fluid supply line, at least one fluid tank and at least one fluid pump. The wiper unit is preferably driven across the surface by a drive unit for wiping.

Preferably, the wiper device has a drive unit which moves the wiper unit over the surface linearly, in particular perpendicular to a longitudinal extent of the wiper lip, for cleaning the surface. Preferably, the drive unit is designed to move the wiper unit linearly, and in particular bidirectionally, over the surface for cleaning the surface, wherein in particular the pressing unit presses the wiper lip against the surface. Preferably, the drive unit is designed to move the wiper unit over the entire area along the surface, in particular for full-surface mechanical cleaning of the surface. Preferably, the pressing unit, in particular the at least one spring element, is designed to exert a pressing force on the wiper lip, in particular for flat contact of the wiper lip on the surface along a longitudinal axis of the wiper lip. Preferably, the pressing unit, in particular the at least one spring element, is designed to exert a minimum pressing force on the wiper lip, in particular for pressing the wiper lip against the surface with a uniform pressure of at least 10 N/m, preferably of at least 14 N/m, particularly preferably of at least 20 N/m. Preferably, the wiper lip of the wiper unit is of an interchangeable form. In particular, the wiper lip of the wiper unit can be designed to be interchangeable without tools. In particular, the wiper lip of the wiper unit can be plug-and-play interchangeable. Preferably, the at least one spring element extends over at least 50%, preferably at least 75% and most preferably completely over an extent of the wiper lip along the longitudinal axis of the wiper lip. A “longitudinal axis” of an object should be understood in particular to mean an axis which runs parallel to a longest edge of a smallest geometric cuboid which just completely encloses the object, and preferably runs through a geometric center of the object. Preferably, the pressing unit is in a different form from a spring rail. Preferably, the pressing unit is designed to exert a pressing force on the wiper lip, wherein a counterforce on an object, such as the vehicle or a housing of the sensor system, originates from the wiper arm and from the wiper arm via the drive unit, and in particular via the sensor system. Preferably, the pressing unit is of a different form from a rod, in particular a metal rod, having in particular a curved shape in an unloaded state, such as in particular a spring rail.

Preferably, the drive unit is designed, in particular between operating states of the wiper unit, to move the wiper unit into a parking position, in which the wiper lip is in particular pressed away from the pressing unit to a stop to relieve the load on the at least one spring element and/or in which the wiper lip is arranged at a distance from the surface. For example, the surface, in particular the covering wall, may be tapered on at least one side. In particular, the at least one covering wall may have at least one ramp element on at least one side. For example, the drive unit may be designed to drive the wiper unit from the parking position to the surface over the at least one ramp element for wiping. For example, the drive unit may be designed to drive the wiper unit over the at least one ramp element of the surface to the parking position for wiping the surface.

Due to the embodiment according to the invention of the wiper device, reliable cleaning of the window element can be achieved. In particular, advantageous properties can be achieved with regard to the reliability of the sensor system to be cleaned. In particular, an advantageously high reliability standard for the operation of the sensor system for the detection of objects can be achieved.

Furthermore, it is proposed that the at least one wiper unit comprises at least one wiper arm, in which the wiper lip is largely arranged and in which the wiper lip is movably mounted against and along with, in particular parallel to, a pressing force of the spring element. Preferably, a longitudinal axis of the at least one wiper arm is oriented parallel to the at least one surface. Preferably, the at least one surface is at least essentially rectangular. Preferably, the at least one wiper arm extends over at least the length of an edge of the at least one surface. Preferably, the at least one wiper arm is connected to the drive unit at at least one end of an extent of the at least one wiper arm along the longitudinal axis of the at least one wiper arm. Preferably, the at least one wiper arm is connected to the drive unit at both ends of the extent of the at least one wiper arm along the longitudinal axis of the at least one wiper arm. Preferably, the at least one wiper arm is in the form of a U-shaped strip, in particular a metal strip, which in cross-section is perpendicular to the longitudinal axis of the at least one wiper arm. Preferably, the at least one wiper arm has a U-shaped profile, in particular in relation to the cross-section being perpendicular to the longitudinal axis of the at least one wiper arm. Preferably, the at least one wiper arm is at least essentially rectangular. Preferably, the at least one wiper arm bounds a wiper cavity, in which the wiper lip is largely arranged. Preferably, the pressing unit is at least largely arranged in the wiper cavity. Preferably, an open side of the wiper arm, in particular in relation to the U-shaped profile, is oriented towards the surface. Preferably, the pressing unit is designed to press the wiper lip through the open side of the at least one wiper arm onto the pane. Preferably, the pressing unit is arranged between the wiper lip and a closed side of the wiper arm facing away from the open side. Preferably, the drive unit is firmly connected to the vehicle or the sensor system. Preferably, the at least one wiper arm is firmly connected to the drive unit. Preferably, the pressing unit is designed to press the wiper lip onto the surface against the at least one wiper arm, in particular against the drive unit, in particular against the vehicle, in particular against the sensor system. Preferably, the at least one wiper lip is movably mounted in the wiper cavity. Preferably, the at least one wiper lip is mounted on the wiper arm so as to be movable perpendicularly to the longitudinal axis of the wiper lip. For example, the wiper unit may have a linear guide unit, which supports the wiper lip movably on the wiper arm. For example, the pressing unit may be in the form of part of the linear guide unit. An advantageously robust wiper unit can be achieved, which in particular can guide the wiper lip advantageously powerfully over the surface.

Furthermore, it is proposed that at least one spring element is in the form of a coil spring. Alternatively, at least one spring element can be in the form of a volute spring. The at least one spring element can be made of metal or plastic. An advantageously cost-effective pressing unit can be achieved.

Furthermore, it is proposed that the at least one spring element is in the form of an air spring. For example, the at least one spring element may be in the form of a plastic element which encloses an air spring cavity in an airtight manner. Preferably, the air spring cavity is filled with air. Preferably, the at least one spring element, which is in particular in the form of an air spring, is made of an artificial or natural elastomer. An advantageously light pressing unit, especially with regard to weight, can be achieved.

Furthermore, it is proposed that the at least one spring element is in the form of a foam spring. For example, the at least one spring element may be in the form of a plastic element which encloses a number of air spring cavities. Preferably, the air spring cavities are filled with air. Preferably, the air spring cavities are coupled to ambient air. Preferably, the at least one spring element, which is in particular in the form of a foam spring, is made from an artificial or natural elastomer. An advantageously cost-effective and light pressing unit can be achieved. In particular, an advantageously rapidly installable spring element can be achieved.

Furthermore, it is proposed that the at least one spring element is in the form of a leaf spring. Preferably, the spring element in the form of a leaf spring is made of metal. An advantageously robust and/or durable spring element can be achieved.

Furthermore, it is proposed that the pressing unit has at least two identical spring elements. Preferably, the at least two identical spring elements are arranged in opposite end areas of the extent of the wiper lip along the longitudinal axis of the wiper lip. The pressing unit may have three, four, five, or the like spring elements distributed equidistantly along the extent of the wiper lip and along the longitudinal axis of the wiper lip, in particular for uniform pressing of the wiper lip against the surface. An advantageous pressing effect at defined points can be achieved.

Furthermore, it is proposed that the pressing unit has at least two different spring elements. Preferably, the at least two different spring elements are arranged in opposite end areas of the extent of the wiper lip along the longitudinal axis of the wiper lip. An advantageously uneven pressure distribution, in particular for an uneven surface, can be achieved.

Furthermore, it is proposed that the at least one spring element is electrically heated. The at least one spring element can be at least partially in the form of heating wire. The at least one spring element may be connected to an electrical line of the vehicle and/or the sensor system. Advantageous heatability of the wiper unit can be achieved.

Furthermore, it is proposed that the at least one spring element is formed in one piece with the wiper lip. Preferably, the at least one spring element is at least partially in the form of an air spring and/or at least partially in the form of foam spring and is formed in one piece with the wiper lip. Cavities in the at least one spring element can be filled with another spring element, which is in the form in particular of a foam spring element. Advantageously uncomplicated replacement of the wiper lip with the pressing unit can be achieved. In particular, an advantageously cost-effective pressing unit can be achieved.

In addition, a wiper system is proposed with the sensor system and with a wiper device according to the invention. Advantageous compatibility of the components of the sensor system and the wiper device can be achieved.

In addition, a method is proposed for the operation of a wiper device according to the invention. In particular, the features of the wiper device are analogously also understood as process features for the method for operating the wiper device. Advantageous cleaning of the surface can be achieved.

The wiper device according to the invention, the wiper system according to the invention and/or the method according to the invention should not be limited to the application and embodiment described above. In particular, the wiper device according to the invention, the wiper system according to the invention and/or the method according to the invention may have a number different from a number mentioned herein of individual elements, components and units and steps of the method for the fulfillment of a function described herein. In addition, with the value ranges specified in this disclosure, values within the mentioned limits should also be regarded as disclosed and as arbitrarily usable.

### BRIEF DESCRIPTION OF THE DRAWINGS

Further advantages result from the following drawing description. In the drawing, six exemplary embodiments of the invention are shown. The drawing, the description and the claims contain numerous features in combination. The person skilled in the art will expediently also consider the features individually and combine them to form meaningful further combinations.

In the figures:

FIG. 1 shows a wiper system according to the invention with a sensor system and with a wiper device according to the invention in a schematic representation,

FIG. 2 shows the wiper system according to the invention with a sensor system and with a wiper device according to the invention in a schematic sectional representation,

FIG. 3 shows a method according to the invention in a schematic representation,

FIG. 4 shows an alternative wiper system according to the invention with a sensor system and with an alternative wiper device according to the invention in a schematic representation,

FIG. 5 shows a further alternative wiper system according to the invention with a sensor system and with another alternative wiper device according to the invention in a schematic representation,

FIG. 6 shows a second further alternative wiper system with a sensor system and with a wiper device according to the invention in a schematic sectional representation,

FIG. 7 shows a third further alternative wiper system with a sensor system and with a wiper device according to the invention in a schematic sectional representation and

FIG. 8 shows a fourth further alternative wiper system with a sensor system and with a wiper device according to the invention in a schematic sectional representation.

### DETAILED DESCRIPTION

FIG. 1 shows a wiper system 48a. The wiper system 48a comprises a sensor system 30a. The wiper system 48a comprises a wiper device 10a.

The sensor system 30a is in the form of a lidar system, in particular of a lidar sensor. The sensor system 30a is provided for detecting and/or measuring objects. The sensor system 30a is provided for use on a vehicle (not shown). The sensor system 30a has a lidar unit 32a. The lidar unit 32a has a lidar sensor element (not shown). The lidar unit 32a has a lidar housing 34a, in which the lidar sensor element is arranged. The sensor system 30a has a covering wall 36a, which allows a laser beam of the sensor systems 30a to emanate from the lidar housing 34a and which is in particular transparent for a detection wavelength of the lidar sensor element. The covering wall 36a partially covers the sensor system 30a on the outside. The covering wall 36a forms in particular a front part of the lidar housing 34a. The covering wall 36a is made of glass and/or polycarbonate. The covering wall 36a defines a surface 38a of the sensor systems 30a as an outer surface 40a of the covering wall 36a. The surface 38a is rectangular. The sensor system 30a is connected to a computing unit, in particular of the vehicle, for data transfer.

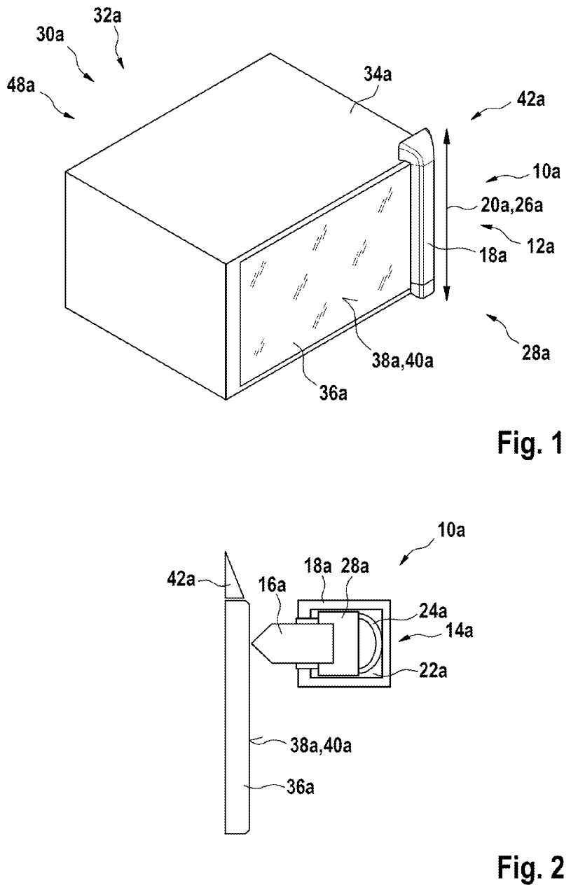

The wiper device 10a is designed for wiping the sensor system 30a. The wiper device 10a comprises a wiper unit 12a. The wiper unit 12a comprises a wiper lip 16a for wiping the surface 38a of the sensor system 30a (see FIG. 2). The wiper lip 16a is of a rubber-like form. In particular, the wiper lip 16a is formed from a natural and/or artificial elastomer. In particular, the wiper unit 12a is provided for cleaning the covering wall 36a mechanically, in particular by means of the wiper lip 16a.

The wiper unit 12a has a wiper arm 18a. A longitudinal axis 20a of the wiper arm 18a is oriented parallel to the surface 38a.

The wiper lip 16a is mostly arranged in the wiper arm 18a. The wiper lip 16a is movably mounted in the wiper arm 18a. The wiper arm 18a extends over a shorter edge length of surface 38a.

The wiper arm 18a is in the form of a U-shaped metal strip in a cross-section perpendicular to the longitudinal axis 20a of the wiper arm 18a. The wiper arm 18a has a U-shaped profile, especially with regard to the cross-section perpendicular to the longitudinal axis 20a of the wiper arm 18a. An open side of the wiper arm 18a, especially with regard to the U-shaped profile, is oriented facing towards the surface 38a. The wiper arm 18a is designed without a spoiler element. In particular, one side of the wiper arm 18a facing away from the surface 38a has a flat outer surface. In particular, the outer surface of the side of the wiper arm 18a facing away from the surface 38a is oriented parallel to the surface 38a.

The wiper arm 18a is rectangular (cf. FIGS. 1 and 2). The wiper arm 18a bounds a wiper cavity 22a, in which the wiper lip 16a is largely arranged. The wiper lip 16a is movably mounted in the wiper cavity 22a. The wiper lip 16a is mounted on the wiper arm 18a so as to be movable perpendicular to a longitudinal axis 26a of the wiper lip 16a. For example, the wiper unit 12a has a linear guide unit 28a, which supports the wiper lip 16a movably on the wiper arm 18a. Preferably, the wiper lip 16a is designed to be able to be inserted into the linear guide unit 28a along its longitudinal axis 26a to connect the wiper lip 16a to the linear guide unit 28a.

The wiper device 10a has a drive unit (not shown), which moves the wiper unit 12a linearly over the surface 38a for cleaning the surface 38a. The wiper arm 18a is firmly connected to the drive unit. The wiper unit 12a is driven across the surface 38a by a drive unit (not shown) for wiping. The drive unit is designed to move the wiper unit 12a over the entire area along the surface 38a, in particular for full-surface mechanical cleaning of the surface 38a. The drive unit is firmly connected to the sensor system 30a. The sensor system 30a is firmly connected to the vehicle. The wiper arm 18a is connected to the drive unit at one end of the extent of the wiper arm 18a along the longitudinal axis 20a of the wiper arm 18a. The drive unit is designed to move the wiper unit 12a linearly, and in particular bidirectionally, over the surface 38a for cleaning the surface 38a, wherein a pressing unit 14a presses the wiper lip 16a against the surface 38a.

The drive unit is designed to move the wiper unit 12a, in particular between operating states of the wiper unit 12a, into a parking position, in which the wiper lip 16a is pressed away from the pressing unit 14a to a stop to relieve the load on a spring element 24a and in which the wiper lip 16a is arranged at a distance from the surface 38a. The covering wall 36a has a ramp element 42a on one side. The drive unit is designed to move the wiper unit 12a from the parking position via the ramp element 42a against the surface 38a for wiping. The drive unit is designed to move the wiper unit 12a across the ramp element 42a from the surface 38a to the parking position to stop the wiping of the surface 38a.

The wiper device 10a comprises the pressing unit 14a. The pressing unit 14a is arranged in the wiper cavity 22a. The pressing unit 14a is arranged between the wiper lip 16a and a closed side of the wiper arm 18a facing away from the open side. The pressing unit 14a is designed to press the wiper lip 16a through the open side of the wiper arm 18a onto the covering wall 36a, in particular the surface 38a. The pressing unit 14a is designed to press the wiper lip 16a via the wiper arm 18a towards the vehicle against the surface 38a by means of the drive unit. The pressing unit 14a has a spring element 24a for pressing the wiper unit 12a, in particular the wiper lip 16a, against the surface 38a. The wiper lip 16a is mounted in the wiper arm 18a so as to be movable against and along with a pressing force of the spring element 24a. The spring element 24a is in the form of a leaf spring. The spring element 24a, which is in the form of a leaf spring, is made of metal. The spring element 24a extends completely over the extent of the wiper lip 16a along the longitudinal axis 26a of the wiper lip 16a. The pressing unit 14a, in particular the spring element 24a, is designed to exert a pressing force on the wiper lip 16a, in particular for planar contact of the wiper lip 16a on the surface 38a along a longitudinal axis 26a of the wiper lip 16a. The pressing unit 14a, in particular the spring element 24a, is designed to exert a minimum pressing force on the wiper lip 16a, in particular for pressing the wiper lip 16a against the surface 38a with a uniform pressure of at least 10 N/m, preferably of at least 14 N/m. The wiper lip 16a of the wiper unit 12a is interchangeable. In particular, the wiper lip 16a of the wiper unit 12a is interchangeable without tools. The spring element 24a is electrically heated. The spring element 24a is in the form of a heating wire. The spring element 24a is connected to an electrical line of the vehicle.

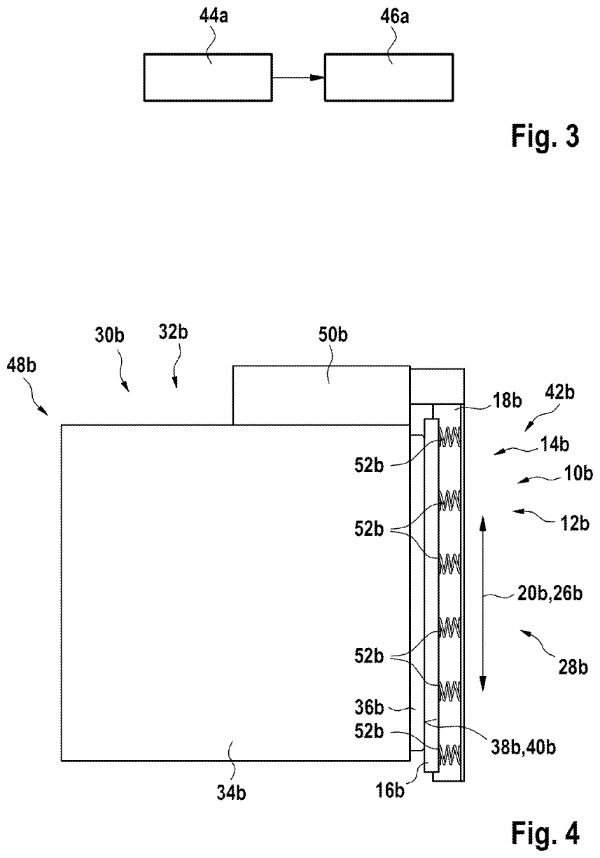

FIG. 3 shows a method for operating the wiper device 10a.

In a step of the method, in particular an operating step 44a, the wiper unit 12a is moved from the parking position to the surface 38a and back and forth across the surface 38a at least once. In a step of the method, in particular a parking step 46a, the wiper unit 12a is moved from the surface 38a to the parking position.

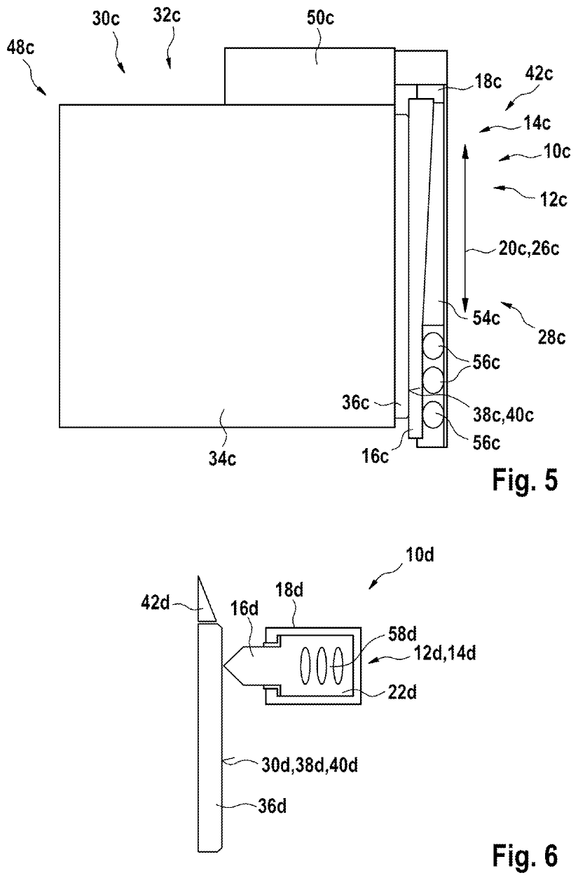

In FIGS. 4 and 5, another exemplary embodiment of the invention is shown. The following descriptions and the drawings are essentially limited to the differences between the embodiments, wherein with regard to identically designated components, in particular with regard to components with the same reference characters, in principle reference can also be made to the drawings and/or the description of the other exemplary embodiments, in particular FIGS. 1 to 3. To distinguish the exemplary embodiments, the letter a is followed by the reference characters of the embodiment in FIGS. 1 to 3. In the embodiments of FIGS. 4 and 5, the letter a is replaced by the letters b and c.

FIG. 4 shows an alternative wiper system 48b. The wiper system 48b has a sensor system 30b. The wiper system 48b has a wiper device 10b. The wiper device 10b comprises a wiper unit 12b. The wiper system 48b has a pressing unit 14b.

The sensor system 30b is in the form of a lidar sensor. The sensor system 30b is provided for the detection and/or measurement of objects. The sensor system 30b is provided for use on a vehicle (not shown). The sensor system 30b has a lidar unit 32b. The lidar unit 32b has a lidar sensor element (not shown). The lidar unit 32b has a lidar housing 34b, in which the lidar sensor element is arranged. The sensor system 30b has a covering wall 36b, which allows a laser beam of the sensor system 30b to emanate from the lidar housing 34b and which is transparent for a detection wavelength of the lidar sensor element. The covering wall 36b partially covers the sensor system 30b to the outside. The covering wall 36b forms in particular a front part of the lidar housing 34b. The covering wall 36b is made of glass and/or polycarbonate. The covering wall 36b defines a surface 38b of the sensor system 30b as an outer surface 40b of the covering wall 36b. The surface 38b is rectangular. The sensor system 30b is connected to a computing unit, in particular of the vehicle, for data transfer.

The wiper device 10b has a drive unit 50b (schematically indicated), which moves the wiper unit 12b linearly over the surface 38b for cleaning the surface 38b.

In particular, the exemplary embodiment which is shown in FIG. 4 differs from the exemplary embodiment of the preceding figures by a different embodiment of the pressing unit 14b.

The pressing unit 14b has at least two identical spring elements 52b. The pressing unit 14b has six identical spring elements 52b as an example. Two identical spring elements 52b of the six spring elements 52b are arranged in opposite end areas of the extent of a wiper lip 16b along a longitudinal axis 26b of the wiper lip 16b. The pressing unit 14b has six spring elements 52b distributed equidistantly along an extent of the wiper lip 16b along the longitudinal axis 26b of the wiper lip 16b, in particular for uniform pressing of the wiper lip 16b against the surface 38b. The spring elements 52b are arranged equidistantly distributed, in particular along the extent of the wiper lip 16b along the longitudinal axis 26b of the wiper lip 16b. The spring elements 52b are each in the form of a coil spring. The spring elements 52b are made of a metal. The spring elements 52b are electrically heated. The spring elements 52b are in the form of heating wire. The spring elements 52b are connected to an electrical line of the vehicle.

FIG. 5 shows another alternative wiper system 48c. The wiper system 48c has a sensor system 30c. The wiper system 48c has a wiper device 10c. The wiper device 10c comprises a wiper unit 12c. The wiper system 48c has a pressing unit 14c.

The sensor system 30c is in the form of a lidar sensor. The sensor system 30c is provided for the detection and/or measurement of objects. The sensor system 30c is provided for use on a vehicle (not shown). The sensor system 30c has a lidar unit 32c. The lidar unit 32c has a lidar sensor element (not shown). The lidar unit 32c has a lidar housing 34c, in which the lidar sensor element is arranged. The sensor system 30c has a covering wall 36c, which allows a laser beam of the sensor system 30c to emanate from the lidar housing 34c and which is transparent for a detection wavelength of the lidar sensor element. The covering wall 36c partially covers the sensor system 30c to the outside. The covering wall 36c forms in particular a front part of the lidar housing 34c. The covering wall 36c is made of glass and/or polycarbonate. The covering wall 36c defines a surface 38c of the sensor system 30c as an outer surface 40c of the covering wall 36c. The surface 38c is rectangular. The sensor system 30c is connected to a computing unit, in particular of the vehicle, for data transfer.

The wiper device 10c has a drive unit 50c (schematically indicated), which moves the wiper unit linearly over the surface 38c 12c for cleaning the surface 38c.

In particular, the exemplary embodiment shown in FIG. 5 differs from the exemplary embodiment of the preceding figures by another embodiment of the pressing unit 14c.

The pressing unit 14c has at least two identical spring elements 56c. The pressing unit 14c has three identical spring elements 56c by way of example. The three identical spring elements 56c are each in the form of an air spring. The spring elements 56c are made of an artificial elastomer with air inclusion.

The pressing unit 14c has at least two different spring elements 54c, 56c. The two different spring elements 54c, 56c are arranged in opposite end areas of the extent of the wiper lip 16c along the longitudinal axis 26c of the wiper lip 16c. A spring element 54c of at least two different spring elements 54c, 56c is in the form of a foam spring. The spring element 54c in the form of a foam spring is designed to exert a variable pressing force on the wiper lip 16c along a longitudinal axis 26c, in particular increasing away from the drive unit 50c. The spring element 54c in the form of a foam spring is designed to exert an equally large pressing force on the wiper lip 16c at an end facing towards the spring elements 56c as the spring elements 56c in the form of air springs. The spring element 54c in the form of a foam spring extends over at least 50% of the extent of the wiper lip 16c along the longitudinal axis 26c of the wiper lip 16c.

The embodiments of the pressing units 14a, 14b, 14c of the individual figures should not be understood as fixed solutions, but rather as example solutions for pressing the wiper lip 16a, 16b, 16c against the surface 38a, 38b, 38c for certain requirements. The individual features of the pressing units 14a, 14b, 14c can therefore be fully combined with each other in any (not shown) combinations for the invention to achieve certain pressing advantages, in particular for differently shaped surfaces 38a, 38b, 38c.

FIG. 6 shows a second alternative wiper system 48d. In particular, the exemplary embodiment which is shown in FIG. 6 differs from the exemplary embodiment of the preceding figures by another embodiment of a pressing unit 14d. The wiper system 48d comprises a wiper device 10d. The wiper device 10d comprises a wiper unit 12d. The wiper unit 12d comprises a wiper lip 16d for wiping a surface 38d of the sensor system 30d. The pressing unit 14d has a spring element 58d.

The spring element 58d is formed in one piece with the wiper lip 16d. The spring element 58d is in the form of an air spring and is formed in one piece with the wiper lip 16d. In particular, the spring element 58d is made of the same material as the wiper lip 16d and bounds a cavity filled with air.

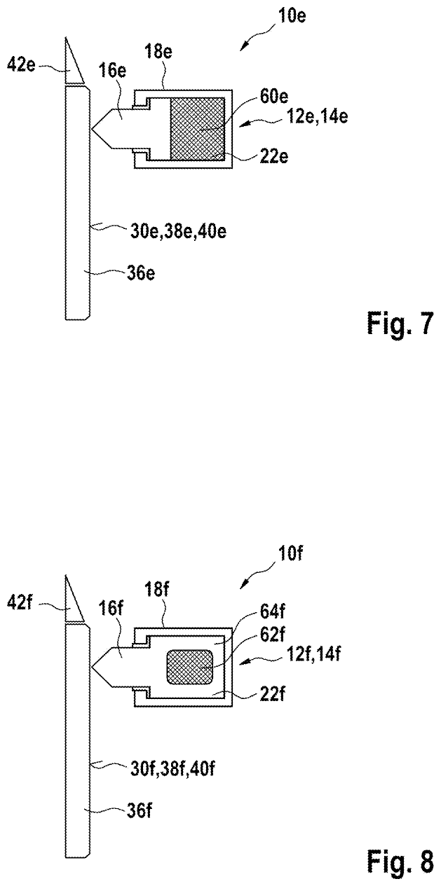

FIG. 7 shows a third alternative wiper system 48e. In particular, the exemplary embodiment which is shown in FIG. 7 differs from the embodiment of the preceding figures by another embodiment of a pressing unit 14e. The wiper system 48e includes a wiper device 10e. The wiper device 10e comprises a wiper unit 12e. The wiper unit 12e includes a wiper lip 16e for wiping a surface 38e of the sensor system 30e. The pressing unit 14e has a spring element 60e.

The spring element 60e is in the form of a foam spring and is formed in one piece with the wiper lip 16e. The spring element 60e is glued to the wiper lip 16e.

FIG. 8 shows a fourth further alternative wiper system 48f. In particular, the exemplary embodiment which is shown in FIG. 8 differs from the embodiment of the preceding figures by another embodiment of a pressing unit 14f. The wiper system 48f comprises a wiper device 10f. The wiper device 10f comprises a wiper unit 12f The wiper unit 12f comprises a wiper lip 16f for wiping a surface 38f of the sensor system 30f. The pressing unit 14f has two spring elements 62f, 64f.

The spring element 64f is formed in one piece with the wiper lip 16f. The spring element 64f is in the form of an air spring and is formed in one piece with the wiper lip 16f. In particular, the spring element 64f is formed from the same material as the wiper lip 16f and bounds a cavity. The spring element 62f is in the form of a foam spring. The spring element 62f is glued to the spring element 64f, in particular to the wiper lip 16f. The spring element 62f is arranged, in particular glued, in the cavity bounded by the spring element 64f.

1. A wiper device for wiping a sensor system (30a-30f) with at least one wiper unit (12a-12f), wherein the wiper unit (12a-12f) comprises at least one wiper lip (16a-16f) for wiping a surface (38a-38f) of the sensor system (30a-30f) and the wiper device comprises at least one pressing unit (14a-14f), wherein the pressing unit (14a-14f) comprises at least one spring element (24a; 52b; 54c, 56c; 58d; 60e; 62f, 64f) for pressing the wiper unit (12a-12f) against the surface (38a-38f).

2. The wiper device according to claim 1, wherein the at least one wiper unit (12a-12f) comprises at least one wiper arm (18a-18f), in which the wiper lip (16a-16f) is largely arranged and in which the wiper lip (16a-16f) is movably mounted against and along with a pressing force of the spring element (24a; 52b; 54c, 56c; 58d; 60e; 62f, 64f).

3. The wiper device according to claim 1, wherein the at least one spring element (52b) is in the form of a coil spring.

4. The wiper device according to claim 1, wherein the at least one spring element (56c) is in the form of an air spring.

5. The wiper device according to claim 1, wherein the at least one spring element (54c) is in the form of a foam spring.

6. The wiper device according to claim 1, wherein the at least one spring element (24c) is in the form of a leaf spring.

7. The wiper device according to claim 1, wherein the pressing unit (14b) has at least two identical spring elements (52b).

8. The wiper device according to claim 1, wherein the pressing unit (14c; 14f) has at least two different spring elements (54c, 56c; 62f, 64f).

9. The wiper device according to claim 1, wherein the at least one spring element (24a; 52b) is electrically heated.

10. The wiper device according to claim 1, wherein the at least one spring element (58d; 60e; 62f; 64f) is formed in one piece with the wiper lip (16d; 16e; 16f).

11. A wiper system with the sensor system (30a; 30b; 30c) and with a wiper device (10a; 10b; 10c) according to claim 1.

12. The wiper system according to claim 11, wherein the sensor system (30a; 30b; 30c) is a lidar system.
